(19) United States
(12) Patent Application Publication
(10) Pub. No.: US 2006/0028026 A1
(43) Pub. Date: Feb. 9, 2006

(54) Wave-power generation system

(76) Inventor: Myung Shik Yim, Busan (KR)

Correspondence Address: ST. ONGE STEWARD JOHNSTON & REENS, LLC, 986 BEDFORD STREET, STAMFORD, CT, 06905-5619, US

(21) Appl. No.: 11/244,125

(22) Filed: Oct. 5, 2005

Related U.S. Application Data
(63) Continuation of application No. PCT/KR04/00874, filed on Apr. 14, 2004.

(30) Foreign Application Priority Data
Apr. 19, 2003 (KR) 10-2003-24875

(51) Int. Cl. F03B 13/12; F03B 13/10; H02P 9/04

(52) U.S. Cl. 290/53

(57) ABSTRACT

Disclosed is a wave-power generation system. The system includes a stationary frame, a float structure installed to the stationary frame, a rotary shaft coupled to a generator and rotatably installed to the stationary frame, a rotary drive coupled to the rotary shaft of the generator via a one-way clutch, a three-node link rotatably installed at a point P of the stationary frame, a float installed to one end of the three-node link, a rope having one end coupled to the other end of the three-node link and the other end wound around the rotary drive, a flywheel installed to the rotary shaft, and a resiliently recovering member having one end coupled to the stationary frame and the other end coupled to the rotary drive.

This application is a continuation of pending International Patent Application No. PCT/KR2004/000874 filed on Apr. 14, 2004, which designates the United States and claims priority of Korean Application No. 10-2003-24875 filed on Apr. 19, 2003.

### FIELD OF THE INVENTION

The present invention relates to a wave-power generation system, and more particularly, to a wave-power generation system converting kinetic energy into rotational energy using the forces of low and high tide to generate electric power.

### BACKGROUND ART

Currently, electric power is generated by use of petroleum, fossil fuel, atomic energy, and the like. Since reserves of the petroleum and fossil fuel are limited, it should be exhausted with the passage of time. For the atomic energy, a usable period of uranium is limited because of finite exhaustion thereof and serious issue of radioactive waste.

Meanwhile, wind power or solar energy has advantages in that it can be infinitely utilized and does not cause harm to the public. However, it is difficult to search the optimum position of the wind since a wind direction is different depending upon a season and position. For the solar energy, there is a disadvantage in that since the percentage of sunshine is limited, a large-scale apparatus and an efficient energy transforming technique are required to recover the limited sunshine, which increases manufacturing costs.

Recently, power generating apparatuses have been proposed using tidal power or wave power. One typical example of those is disclosed in Korean Unexamined Patent Publication No. 2002-71492, in which the forces of low and high tide are transferred to a generator through float balls. Referring to FIG. 1, when a float ball 60 is lowered, a rotary shaft idles by a one-way clutch 75. Whenever the sea rolls, the rotary shaft is continuously rotated in one direction to generate the power.

According to the prior art wave-power generation system, however, since only a simple principle is disclosed, several problems may occur in actual operation. For example, a float shaft 70 provided with the float ball 60 is formed with teeth 74, and the one-way clutch 75 is directly engaged with the teeth 74. When the sea rolls, the one-way clutch 75 may be detached from the teeth 64 of the float shaft 70 according to fluctuation of float shaft 70 and the one-way clutch 75 in a moment, which it is not possible to certainly transfer a drive force.

In addition, inertia force transferred to a rotary shaft 40 of the generator from the one-way clutch 75 is small. If there are no further waves, the rotation is likely distinguished at once. There is another drawback in that the prior art cannot use a large moment because of only utilizing only lifting force acting on the float balls 60.

Furthermore, rotational speed and rotating force of the rotary shaft 40 depend upon the wave power only. There is another drawback in that in this case the fluctuation of a height of the wave is large it is difficult to stably generate an alternating current.

### DISCLOSURE OF THE INVENTION

Therefore, an object of the present invention is to solve the problems involved in the prior art, and to provide a wave-power generation system, by which when wave power acts instantaneously, an operating state can be stably maintained to generate electric power.

Another object of the present invention is to provide a wave-power generation system capable of applying a rotating force to a rotary shaft using the large moment of leverage.

In order to accomplish the above and other objects, there is provided a wave-power generation system comprising: a stationary frame; a float structure installed to the stationary frame; a rotary shaft coupled to a generator and rotatably installed to the stationary frame; a rotary drive coupled to the rotary shaft of the generator via a one-way clutch; a three-node link rotatably installed at a point of the stationary frame; a float installed to one end of the three-node link; a rope having one end coupled to the other end of the three-node link and the other end wound around the rotary drive; a flywheel installed to the rotary shaft; and a resiliently recovering member having one end coupled to the stationary frame and the other end coupled to the rotary drive.

According another aspect of the present invention, there is provided a wave-power generation system comprising: a stationary frame; a float structure installed to the stationary frame; a rotary shaft coupled to a generator and rotatably installed to the stationary frame; a rotary drive coupled to the rotary shaft of the generator via a one-way clutch; a two-node link having one end fixed to the rotary drive; a float installed to one end of the two-node link; and a flywheel installed to the rotary shaft.

According further another aspect of the present invention, there is provided a wave-power generation system comprising: a first wave-power generation structure including a rotary shaft of a generator rotatably installed to a stationary frame; a rotary drive coupled to the rotary shaft of the generator via a one-way clutch; a three-node link rotatably installed at a point of the stationary frame; a float installed to one end of the three-node link; and a resiliently recovering member having one end coupled to the other end of the three-node link and the other end coupled to the rotary drive; and a second wave-power generation structure including a rotary drive coupled to the rotary shaft of the generator via a one-way clutch; a two-node link having one end fixed to the rotary drive; and a float installed to one end of the two-node link; and a flywheel installed to the rotary shaft; and wherein the wave-power generation structures are arranged along the rotary shaft of the generator, a float structure is installed to the stationary frame, and at least one flywheel is installed to the rotary shaft of the generator.

### BRIEF DESCRIPTION OF DRAWINGS

The above objects, other features and advantages of the present invention will become more apparent by describing the preferred embodiment thereof with reference to the accompanying drawings, in which:

FIG. 1 is a perspective view illustrating one example of a prior art wave-power generation system.

FIG. 2 is a perspective view illustrating a wave-power generation system according to a first preferred embodiment of the present invention.

FIGS. 3a and 3b are side views of the wave-power generation system in FIG. 2.

FIG. 4 is a side view of a wave-power generation system including a resiliently recovering member different from that of the wave-power generation system in FIG. 2.

FIG. 5a is a front view of the wave-power generation system and

FIG. 5b is a top view of the system.

FIG. 6 is a top view illustrating a wave-power generation system according to third embodiment of the present invention.

FIGS. 7a and 7b are views illustrating one example of a one-way clutch employed in the present invention.

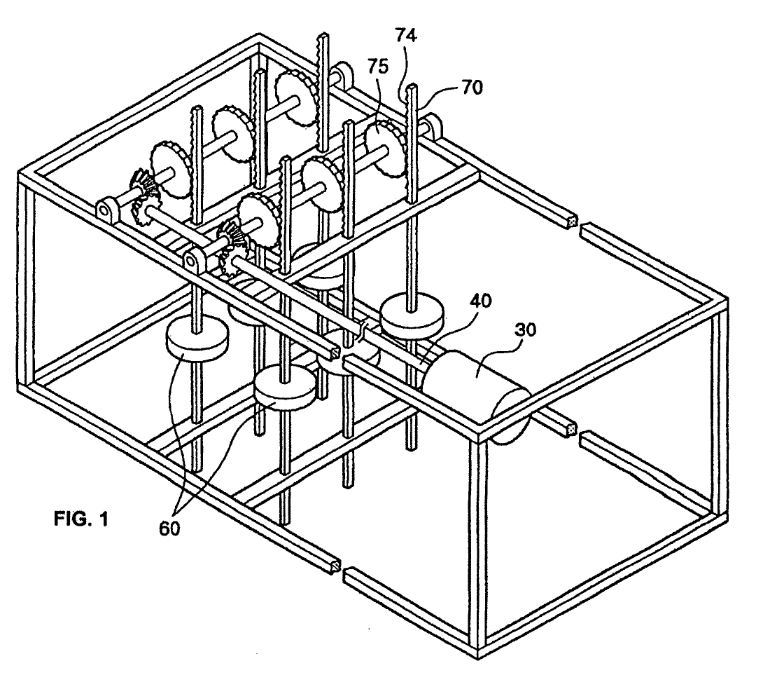

### DETAILED DESCRIPTION OF PREFERRED EMBODIMENTS

Reference will now be made in detail to preferred embodiments of the present invention, examples of which are illustrated in the accompanying drawings.

### First Embodiment

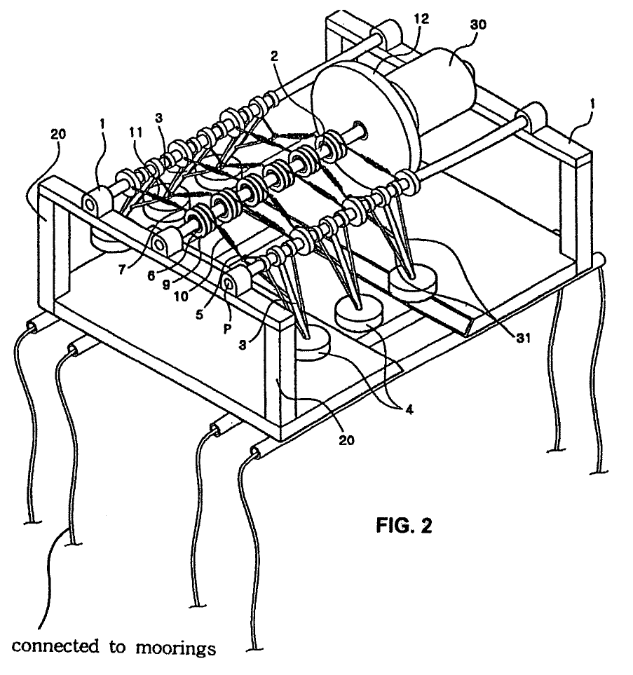

FIGS. 2 through 4 show a wave-power generation system according to a first preferred embodiment of the present invention.

As shown in figures, the wave-power generation system of the present invention includes a stationary frame 1 for supporting various components, and a float structure 20 for floating the stationary frame 1 on the sea. The stationary frame 1 consists of relatively high-strength members engaged to each other. If the stationary frame 1 is floated on the sea together with the float structure 20, a portion of the stationary frame is exposed from the surface of the sea, while a portion of the stationary frame sinks to the sea.

The stationary frame 1 is provided with a rotary shaft 2 of a generator which is freely rotated on the stationary frame 1. A generator 30 coupled to the rotary shaft generates the power according to the rotation of the rotary shaft 2. The stationary frame 10 includes a bearing (not shown) to rotatably support the rotary shaft 2. The generator 30 has a conventional structure to generate the power by use of relative rotation between magnet and coil.

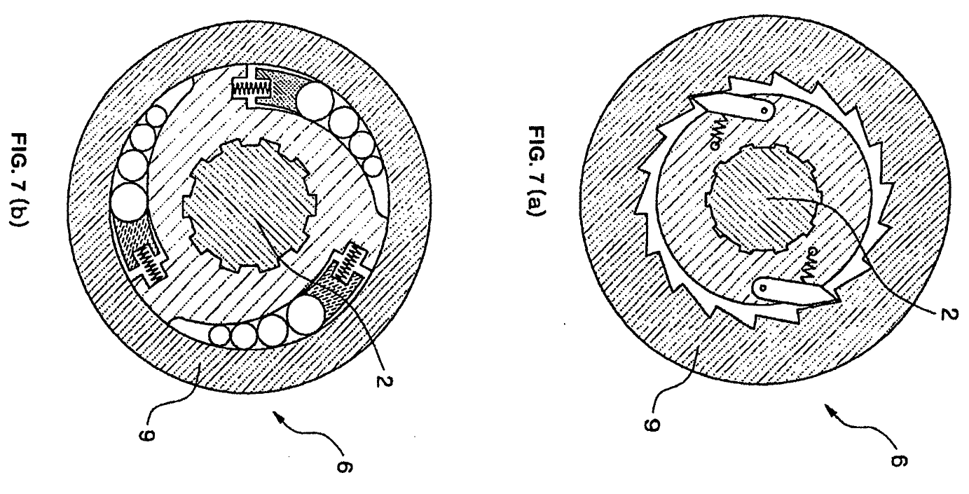

A rotary drive 9 is directly coupled to the rotary shaft 2 of the generator via the one-way clutch 6. When the rotary drive 9 is rotated in one direction, the one-way clutch idles to interrupt the transmission. Consequently, since the rotary shaft can be rotated in one direction only, the rotary shaft may be further supplied with the rotary force whenever the sea rolls. FIG. 7 shows examples of applicable one-way clutch 6.

A three-node link 3 is operately installed at a point P of the stationary frame 1. The three-node link refers to a member of which little relative displacement is between the point P, a coupling point of a rope 5 and an installing point of a float 4. The three-node link may consist of crossed rods, as shown in the embodiment, or may be made of a flat plate. Preferably, support members 31 are installed to the three-node link in front and rear direction relative to the rotary shaft 2.

One free end of the three-node link 3 is coupled to the float 4, while the other free end is coupled to an end portion of the rope 5. The float 4 floats on the sea, and is moved by the waves in a moment.

The other end of the rope 5 is wound around the rotary drive 9. Preferably, the rotary drive 9 is provided on a circumference thereof with a common winding drum. The rotary drive is coupled to the rotary shaft 2 of the generator via the one-way clutch 6.

The rope 5 is coupled to a tension spring 10 at a position facing the three-node link 3, so that the float 4 raised by the waves is quickly returned to its original position by the tension spring.

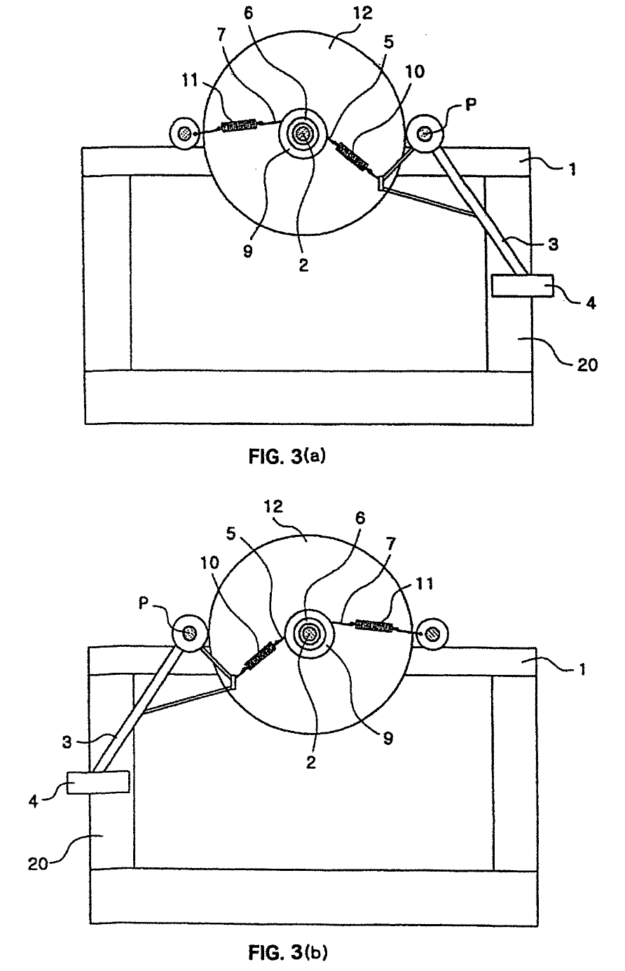

As shown in FIG. 3, the rotary drive 9 is connected to the stationary frame 1 by the rope 7 and the tension spring 11. After the float 4 is raised and then is lowered, the rotary drive 9 can be quickly recovered.

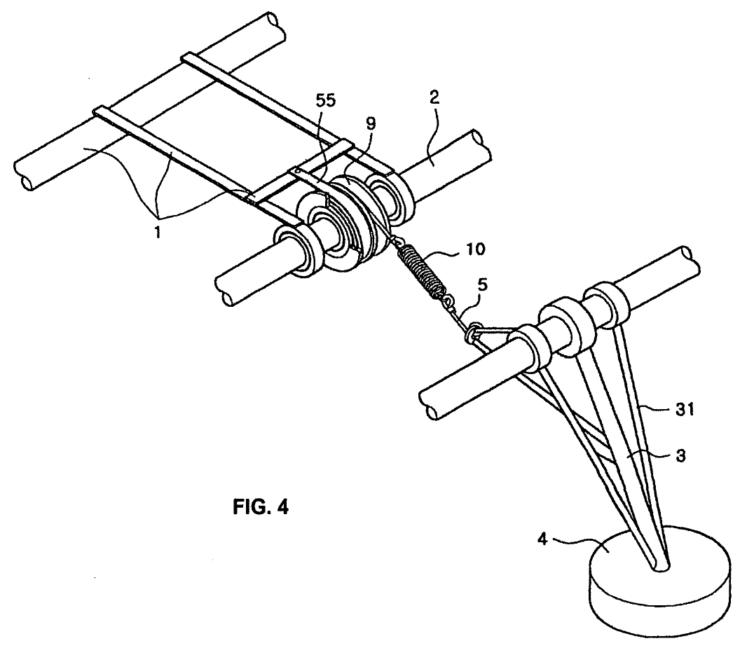

Referring to FIG. 4, if a spiral spring 55 is provided between the stationary 1 and the rotary drive 9, the recovery may be conveniently and smoothly achieved.

As shown in FIG. 2, it is preferable that the three-node links 3 and the floats 4 are installed to the left and right sides of the rotary shaft 2 of the generator, respectively. In this case, the entire structure is stabilized because the weight thereof is balanced, as well as the increased rotating force.

In addition, in order to further increase the rotating force, two or more three-node links 3, the floats 4, the one-way clutches 6 and the ropes 5 may be provided along the rotary shaft 9.

The rotary shaft 2 of the generator is provided with a flywheel 12, so that a deviation of the rotating speed can be reduced by use of large inertial energy and the rotating energy can be retained in the case of no waves.

### Second Embodiment

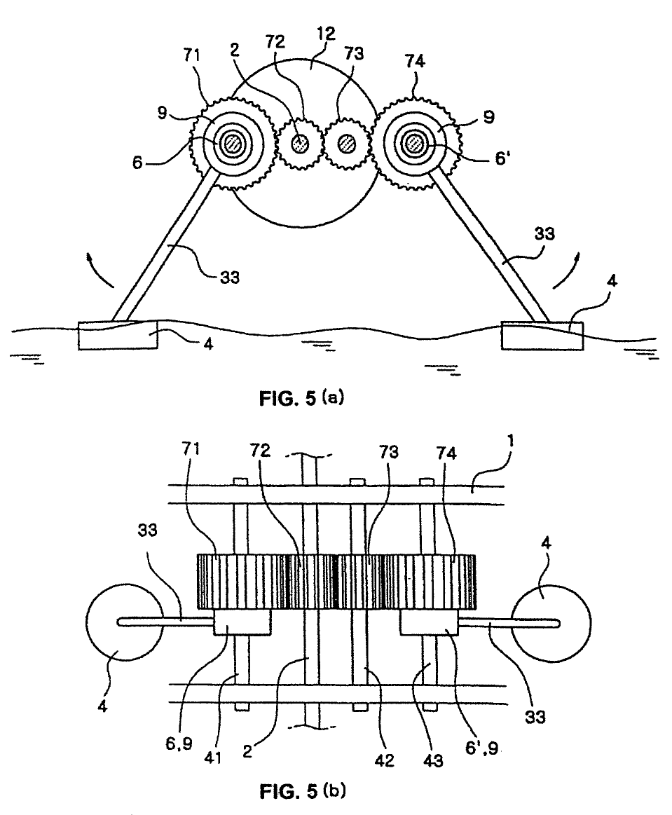

FIG. 5 shows a wave-power generation system according to a second preferred embodiment of the present invention.

Referring to FIG. 5, the wave-power generation system of the present invention includes a stationary frame 1, a float structure 20 installed to the stationary frame 1, a generator's rotary shaft 2 rotatably installed to the stationary frame 1, and a flywheel 12 installed to the rotary shaft 2, which is similar to the first embodiment.

In this embodiment, the rotary drive 9 is coupled to the rotary shaft 2 of the generator via a one-way clutch 6. One end of a two-node link 33 is coupled to the rotary drive 9, and a float 4 is installed to a free end of the two-node link 33.

A follower of the one-way clutch 6 and a first intermediate gear 71 are installed to a first rotating drive shaft 41 installed to the stationary frame 1 in a direction parallel with the rotary shaft 2 of the generator. The first intermediate gear 71 meshes with a second gear 72 installed to the rotary shaft 2 of the generator. As such, when a left float 4 is raised, the first intermediate gear 71 is rotated through the one-way clutch 6, and then the rotary shaft 2 of the generator 2 is rotated by the second intermediate gear 72 meshed with the first intermediate gear 71.

The first intermediate gear 71 has a diameter larger than that of the second intermediate gear 72 to increase a rotating speed.

A third intermediate gear 73 is installed to an intermediate rotary shaft 42 installed parallel with the rotary shaft 2 of the generator. The follower of the one-way clutch 6 and a fourth intermediate gear 74 are installed to a second rotating drive shaft 43 installed to the stationary frame 1 in a direction parallel with the rotary shaft 2 of the generator. The third intermediate gear 73 may be meshed with the second intermediate gear 72 and the fourth intermediate gear 74.

As such, when a right float 4 is raised, the fourth intermediate gear 74 meshed with the third intermediate gear 73 is rotated, and then the second intermediate gear 72 is rotated by the third intermediate gear 73, thereby rotating the rotary shaft 2 of the generator. When the float 4 is lowered, the transmission is interrupted by the one-way clutch 6, while the rotary shaft 2 of the generator is continuously rotated by the flywheel 12.

The fourth intermediate gear 74 has a diameter larger than that of the third intermediate gear 73 to increase a rotating speed.

Two or more pairs of two-node links 33, floats 4, one-way clutches 6 may be installed to the rotary shaft 2 of the generator to achieve a high rotating speed of the rotary shaft.

### Third Embodiment

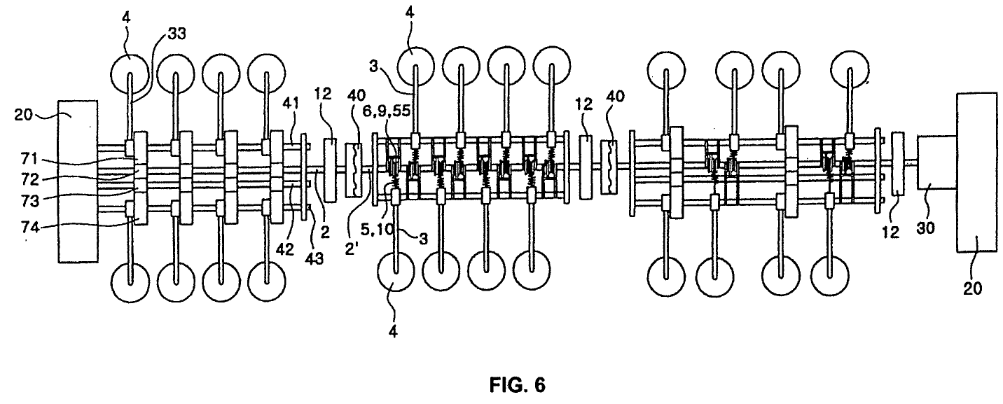

FIG. 6 shows a wave-power generation system according to a third preferred embodiment of the present invention.

Referring to FIG. 6, the wave-power generation system of the present invention includes a rotary shaft 2 of a generator rotatably installed to a stationary frame 1, a rotary drive 9 coupled to the rotary shaft 2 of the generator via a one-way clutch 6, a three-node link 3 rotatably installed at a point P of the stationary frame 1, a float 4 installed to one end of the three-node link 3, and a resiliently recovering member having one end coupled to the other end of the three-node link 3 and the other end coupled to a rope 5. One end of the rope 5 is coupled to the other end of the three-node link 3, and the other end is coupled to the rotary drive 9. One end of the resilient covering member is coupled to the stationary frame 1, and the other end is coupled to the rotary drive 9. The wave-power generating system also includes the rotary drive 9 coupled to the rotary shaft 2 of the generator via the one-way clutch 6, a two-node link 33 having one end fixed to the rotary drive 9, and the float 4 installed to the free end of the two-node link 33. A float structure 20 is installed to the stationary frame 1, and a flywheel 12 is installed to the rotary shaft 2 of the generator.

When the driving force is transmitted to the generator 30, the rotating speed of the rotary shaft 2 of the generator is further increased. An overdriving apparatus 40 may serve as a so-called gear box.

The operation of the wave-power generation system according to the first embodiment of the present invention will now be described.

As shown in FIG. 3, when the float 4 is raised by the waves, the three-node link 3 installed to the float 4 is rotated. As such, the tension is acted on the rope 5 coupled to one end of the three-node link 3 to rotate the rotary drive 9 around which the rope is wound. Finally, the rotary shaft 2 of the generator coupled to the rotary drive 9 via the one-way clutch 6 starts rotating.

When the rotary shaft 2 of the generator rotates, the rotating energy is stored in the flywheel 12. Therefore, a variation of the rotating speed is remarkably reduced to stably rotate the rotary shaft, thereby generating the power by the generator 30.

When the raised float 4 is lowered, the three-node link is rapidly returned to its original position by the tension spring 10. At the same time, the rotary drive 9 is reversely rotated by the tension spring 11 of the rope 7 or the spiral spring 55.

The rotating force of the rotary shaft is more increased by installing the floats 4 to the left and right sides of the rotary shaft. In addition, a plurality of floats 4 is installed along the rotary shaft 2 of the generator to improve the efficiency of the generator.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As apparent from the above description, since the floats are installed to the links coupled to the stationary frame, structure strength of the system is increased.

In addition, a large moment is applied to the rotary shaft by the three-node link to remarkably increase the rotating force of the rotary shaft.

Since the flywheel is installed to the rotary shaft of the generator, the rotary shaft may be stably maintained in the rotating speed and the rotating force in the case the wave power is applied in a moment. Therefore, the system can generate the power stably.

What is claimed is:

1. A wave-power generation system comprising:
a stationary frame;
a float structure installed to the stationary frame;
a rotary shaft coupled to a generator and rotatably installed to the stationary frame;
a rotary drive 9 coupled to the rotary shaft of the generator via a one-way clutch;
a three-node link rotatably installed at a point P of the stationary frame;
a float installed to one end of the three-node link;
a rope having one end coupled to the other end of the three-node link and the other end wound around the rotary drive;
a flywheel installed to the rotary shaft; and
a resiliently recovering member having one end coupled to the stationary frame and the other end coupled to the rotary drive.

2. The wave-power generation system as claimed in claim 1, wherein a tension spring is provided between the rope and the three-node link.

3. The wave-power generation system as claimed in claim 1, wherein the resiliently recovering member includes a tension spring and a spiral spring.

4. The wave-power generation system as claimed in claim 2, wherein the resiliently recovering member includes a tension spring and a spiral spring.

5. The wave-power generation system as claimed in claim 1, wherein the wave-power generation system is installed to left and right sides of the rotary shaft, respectively.

6. The wave-power generation system as claimed in claim 5, wherein at least two sets of the wave-power generation system are installed along the rotary shaft.

7. The wave-power generation system as claimed in claim 6, wherein at least two wave-power generation systems are coupled along the rotary shaft via an overdriving apparatus and the one-way clutch.

8. A wave-power generation system comprising:
a stationary frame;
a float structure installed to the stationary frame;
a rotary shaft coupled to a generator and rotatably installed to the stationary frame;
a rotary drive coupled to the rotary shaft of the generator via a one-way clutch;
a two-node link having one end fixed to the rotary drive;
a float installed to one end of the two-node link; and
a flywheel installed to the rotary shaft.

9. The wave-power generation system as claimed in claim 8, wherein a follower of the one-way clutch and a first intermediate gear are installed to a first rotating drive shaft installed to the stationary frame in a direction parallel with the rotary shaft of the generator, and the first intermediate gear meshes with a second gear installed to the rotary shaft of the generator, in which the first intermediate gear has a diameter larger than that of the second intermediate gear.

10. The wave-power generation system as claimed in claim 9, wherein
a third intermediate gear is installed to an intermediate rotary shaft installed parallel with the rotary shaft of the generator, and the follower of the one-way clutch and a fourth intermediate gear are installed to a second rotating drive shaft installed to the stationary frame in a direction parallel with the rotary shaft of the generator, and the third intermediate gear meshes with the second intermediate gear and the fourth intermediate gear, in which the fourth intermediate gear has a diameter larger than that of the third intermediate gear.

11. The wave-power generation system as claimed in claim 8, wherein at least two sets of the wave-power generation system are installed along the rotary shaft.

12. The wave-power generation system as claimed in claim 11, wherein at least two wave-power generation systems are coupled along the rotary shaft via an overdriving apparatus and the one-way clutch.

13. A wave-power generation system comprising:
a first wave-power generation structure including
a rotary shaft of a generator rotatably installed to a stationary frame;
a rotary drive coupled to the rotary shaft of the generator via a one-way clutch;
a three-node link rotatably installed at a point P of the stationary frame;
a float installed to one end of the three-node link; and
a resiliently recovering member having one end coupled to the other end of the three-node link and the other end coupled to the rotary drive; and
a second wave-power generation structure including
a rotary drive coupled to the rotary shaft of the generator via a one-way clutch;
a two-node link having one end fixed to the rotary drive; and
a float installed to one end of the two-node link; and
a flywheel installed to the rotary shaft; and
wherein the wave-power generation structures are arranged along the rotary shaft of the generator,
a float structure is installed to the stationary frame, and
at least one flywheel is installed to the rotary shaft of the generator.
